(19) United States
(12) Patent Application Publication
(10) Pub. No.: US 2008/0150715 A1
(43) Pub. Date: Jun. 26, 2008

(54) Operation control methods and systems

(75) Inventors: Kuan-Chun Tang, Miaoli County (TW); Yen-Chang Chiu, Taipei County (TW)

Correspondence Address: BIRCH STEWART KOLASCH & BIRCH, PO BOX 747, FALLS CHURCH, VA, 22040-0747, US

(73) Assignee: ELAN MICROELECTRONICS CORPORATION

(21) Appl. No.: 11/826,481

(22) Filed: Jul. 16, 2007

(30) Foreign Application Priority Data
Dec. 21, 2006 (TW) 095148146

(51) Int. Cl. G08B 21/00

(52) U.S. Cl. 340/540

(57) ABSTRACT

Operation control methods and systems. Contacts respectively corresponding to at least two pointers on a touch-sensitive mechanism are detected. Movements of the contacts on the touch-sensitive mechanism are detected, and an operation instruction is determined according to the movements. A host executes the operation instruction by enabling a specific object to perform an operation.

### BACKGROUND OF THE INVENTION

1. Field of the Invention

The disclosure relates generally to operation control methods and systems, and, more particularly to operation control methods and systems integrated with a touch-sensitive mechanism that control operations of a specific object according to multiple contacts on the touch-sensitive mechanism.

2. Description of the Related Art

Recently, touch-sensitive mechanisms are provided in some systems for users performing related operations. For these systems, users can directly perform controls via contact on the touch-sensitive mechanism without complicated command inputs via keypads.

The touch-sensitive mechanism can detect contact positions of pointers such as user fingers or styluses thereon using touch sensing technologies. Capacitance sensing technologies are conventional touch sensing technologies. An electrode matrix arranged in rows and columns are set in a capacitance-style touch-sensitive mechanism. If a pointer contacts or is close to the surface of the touch-sensitive mechanism, the capacitance of the contact point will be changed. The control unit of the touch-sensitive mechanism can detect a change in the quantity of the capacitance, and convert the change quantity into a sensing quantity corresponding to the contact, identifying the contact point and determining whether the contact is valid accordingly.

Given the convenience and variety of touch-sensitive mechanisms, the touch-sensitive mechanisms have become a popular and a necessary input interface for newly developed devices. However, conventional operation control mechanisms for touch-sensitive mechanisms only provide selection and drag functions, not fulfilling control requirements for various devices and applications.

### BRIEF SUMMARY OF THE INVENTION

Operation control methods and systems are provided.

In an embodiment of an operation control method, contacts respectively corresponding to at least two pointers on a touch-sensitive mechanism are detected. Movements of the contacts on the touch-sensitive mechanism are detected, and an operation instruction is determined according to the movements.

An embodiment of an operation control system comprises a touch-sensitive mechanism and a processing module. The processing module detects contacts respectively corresponding to at least two pointers on the touch-sensitive mechanism. The processing module detects movements of the contacts on the touch-sensitive mechanism, and determines an operation instruction according to the movements.

In some embodiments, if the movements of the contacts corresponding to the two pointers on the touch-sensitive mechanism move away from each other, the determined operation instruction is to open a specific object. If the movements of the contacts corresponding to the two pointers on the touch-sensitive mechanism move toward each other, the determined operation instruction is to close a specific object. If the contacts corresponding to the two pointers on the touch-sensitive mechanism present alternately and no movement of the contacts occurs, the determined operation instruction is to enable a specific object to perform a specific operation such as character stepping and drumming. If the contacts corresponding to the two pointers on the touch-sensitive mechanism present alternately and movements of the contacts occur, the determined operation instruction is to enable a specific object to perform a specific operation such as character sliding.

Operation control methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an operation control system;

FIG. 2 is a schematic diagram illustrating an example of a display unit;

FIG. 3 is a flowchart of an embodiment of an operation control method;

FIGS. 4A and 4B are schematic diagrams illustrating an example of an operation to open hands;

FIGS. 5A and 5B are schematic diagrams illustrating an example of an operation to catch an object;

FIG. 6 is a flowchart of an embodiment of a method determining whether a specific operation is character stepping/drumming or character sliding;

FIGS. 7A and 7B are schematic diagrams illustrating an example of an operation of character stepping; and

FIGS. 8A and 8B are schematic diagrams illustrating an example of an operation of character sliding.

### DETAILED DESCRIPTION OF THE INVENTION

Operation control methods and systems are provided.

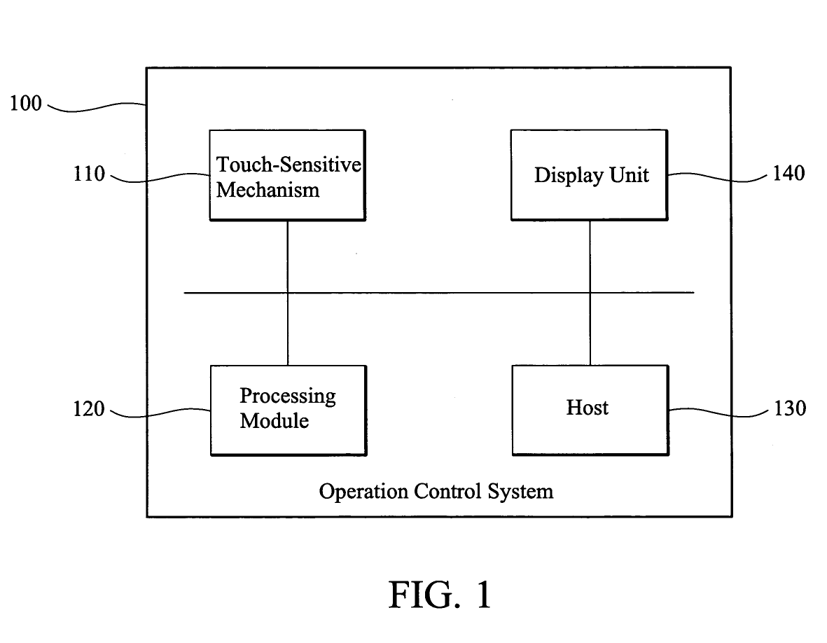

FIG. 1 is a schematic diagram illustrating an embodiment of an operation control system.

The operation control system 100 comprises a touch-sensitive mechanism 110, a processing module 120, a host 130, and a display unit 140. The touch-sensitive mechanism 110 has a touch-sensitive surface. In this embodiment, the touch-sensitive mechanism 110 comprises at least two dimensional sensors, but not limited thereto. The touch-sensitive mechanism 110 may have multi-dimensional sensors. Additionally, the touch-sensitive mechanism 110 may employ any touch sensing technology to detect contact positions and corresponding sensing quantities of pointers such as user fingers or styluses thereon. The processing module 120 may determine an operation instruction according to movements of the contacts corresponding to the pointers on the touch-sensitive mechanism. The host 130 may enable a specific object to perform an operation according to the operation instruction.

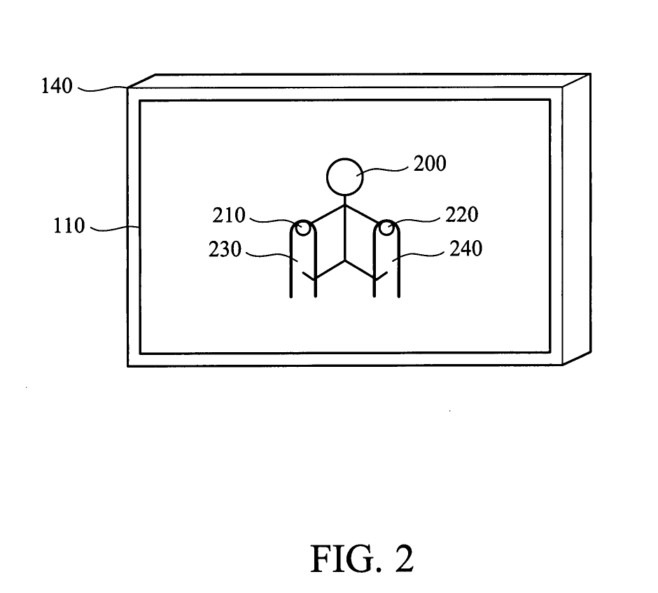

Further, the display unit 140 may display the specific object and the operation performed by the specific object. In some embodiments, the host 130 may play back a series of frames via the display unit 140, completing the operation instruction. In some embodiments, the touch-sensitive mechanism 110 may have a transparent touch-sensitive surface of ITO (Indium Tin Oxide) attached on the display unit 140. If the pointers contact the surface of the touch-sensitive mechanism 110, the contacts respectively correspond to specific portions of the specific object. FIG. 2 is a schematic diagram illustrating an example of a display unit. In this example, the touch-sensitive mechanism 110 may be attached to any side of the display unit 140. The display unit 140 displays a character (specific object) 200 having two hand ends 210 and 220. In this example, if two fingers contact the surface of the touch-sensitive mechanism 1 10, the contact positions respectively correspond to two hand ends 210 and 220 of the character 200. In this manner, control effects of synchronous sensing and displaying can be achieved. It is understood that in some embodiments, the processing module 120 may be a control unit of the touch-sensitive mechanism 110. In some embodiments, the processing module 120 may be a controller such as a CPU or micro-processor.

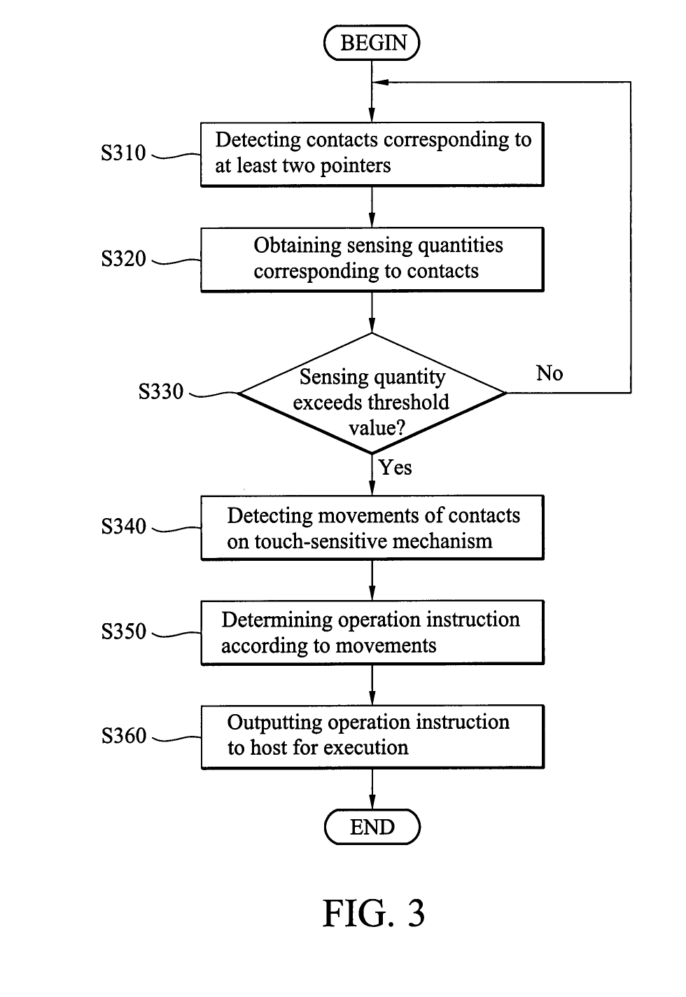

FIG. 3 is a flowchart of an embodiment of an operation control method.

In step S310, contacts of at least two fingers such as fingers or styluses on the touch-sensitive mechanism are detected. In step S320, sensing quantities of respective contacts are obtained. In step S330, it is determined whether each sensing quantity exceeds a threshold value. If not, such that the pointer unwittingly contacted the touch-sensitive mechanism, the contact is omitted, and the procedure returns to step S310. If so, in step S340, movements of the contacts corresponding to the two pointers are detected. In step S350, an operation instruction is determined according to the movements. In step S360, the operation instruction is output to the host for execution. It is noted that during the execution of the operation instruction, the host 130 further displays related operations in the display unit 140.

In some embodiments, various operation instructions can be determined according to the movements of the pointers on the touch-sensitive mechanism. For example, the method for determining the operation instruction is to calculate a first distance between two contact positions, and then determine whether the contacts remain and move. It is understood that determining whether or not the contacts remain, is determined by the sensing quantities corresponding to respective contacts and whether they exceed the threshold values. If so, the contacts remain on the surface of the touch-sensitive mechanism, and a second distance between two contact positions is re-calculated. It is determined whether the second distance is greater than the first distance. If so, the operation instruction is determined to open a specific object according to the positions and/or distances of the contacts. If not, the operation instruction is determined to close a specific object according to the positions and/or distances of the contacts. It is understood that the manner and extent for opening or closing the specific object can be determined according to the positions and/or distances of the contacts. In some embodiments, the action of opening the specific object may be an operation to open a door or hands. Similarly, the manner and extent for closing the specific object can be determined according to the positions and/or distances of the contacts. In some embodiments, the action of closing the specific object may be an operation to close a door or hands.

It is understood that, in some embodiments, a velocity of distance variation between the two contacts may be further detected and recorded, and the manner and extent for opening and/or closing the specific object can be determined according to the velocity, where the behavior may be different in different velocities.

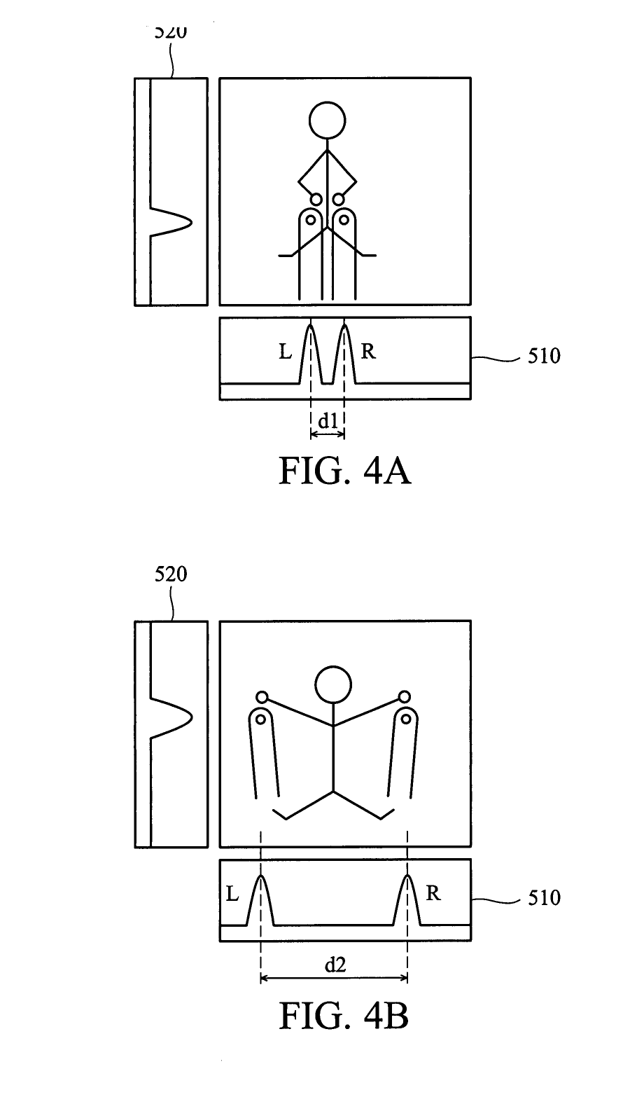

FIGS. 4A and 4B are schematic diagrams illustrating an example of an operation to open hands.

As shown in FIG. 4A, if left and right fingers contact the touch-sensitive mechanism, corresponding sensing quantities (L and R) are obtained, where 510 represents a curve of sensing quantity in X axis, 520 represents a curve of sensing quantity in Y axis. A distance d1 between contact positions of two fingers can be obtained from the curve in X axis. If two fingers still contact the touch-sensitive mechanism and move, a new distance d2 between contact positions of the two fingers can be re-obtained from the curve in X axis. In this example, since two fingers move away from each other, resulting in d2>d1, the operation instruction is to open the specific object such as the hands of a character, as shown in FIG. 4B. Similarly, if two fingers move toward each other, resulting in d2<d1, the operation instruction is to close the hands of the character.

In some embodiments with three pointers, the method for determining the operation instruction is to calculate an original distance between any two contact positions, and then determine whether the contacts remain and move. Similarly, it is determined whether or not the contacts remain by determining whether the sensing quantities corresponding to respective contacts exceed the threshold values. If so, a new distance between any two contacts is re-calculated to determine whether the new distance between any two contacts is less than the corresponding original distance. If so, the operation instruction is determined to catch a specific object. It is understood that the manner and extent for catching the specific object can be determined according to the contact positions, the distances between contacts, and/or the velocity of distance variation of contacts.

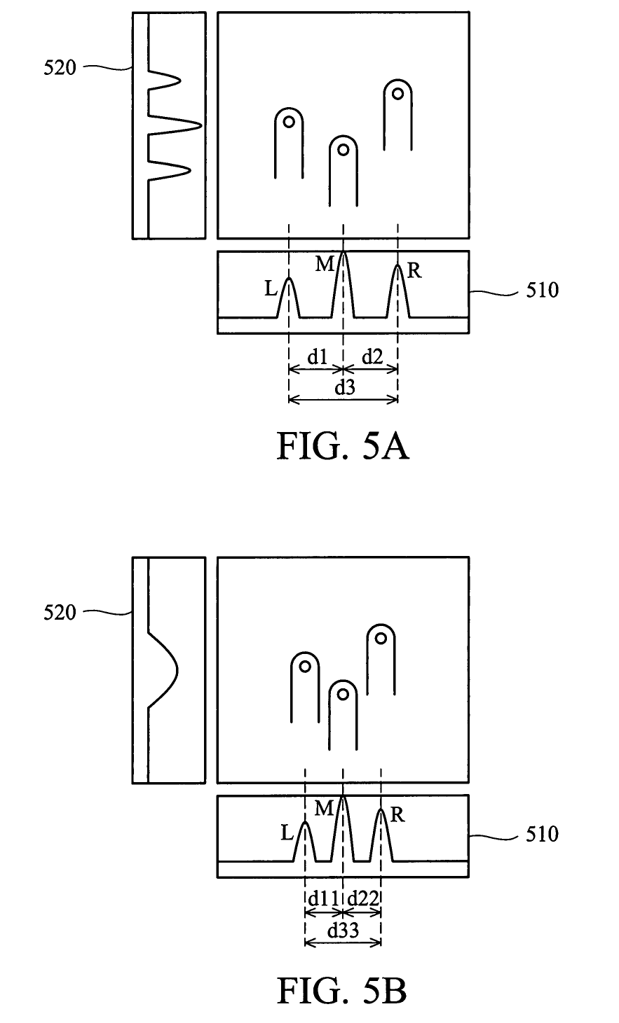

FIGS. 5A and 5B are schematic diagrams illustrating an example of an operation to catch an object.

As shown in FIG. 5A, if left, middle and right fingers contact the touch-sensitive mechanism, corresponding sensing quantities (L, M and R) are obtained, where 510 represents a curve of sensing quantity in X axis, 520 represents a curve of sensing quantity in Y axis. A distance d1 between contact positions of the left and middle fingers, a distance d2 between contact positions of the middle and right fingers, and a distance d3 between contact positions of the left and right fingers can be obtained from the curve in X axis. If three fingers continue to contact the touch-sensitive mechanism and move, a new distance d11 between contact positions of the left and middle fingers, a new distance d22 between contact positions of the middle and right fingers, and a new distance d33 between contact positions of the left and right fingers can be re-obtained from the curve in X axis. In this example, since three fingers move closer together, resulting in d11<d1, d22<d2 or d33<d3, the operation instruction may be a catch behavior, for example, catching the specific object, as shown in FIG. 5B.

In some embodiments, the method for determining the operation instruction is to determine whether the contacts respectively corresponding to two pointers present alternatively. If so, it is determined whether the contacts move. If no movement occurs, the operation instruction is determined to enable a specific object to perform a specific operation comprising character stepping or drumming. If movements occur, the operation instruction is determined to enable a specific object to perform a specific operation comprising character sliding.

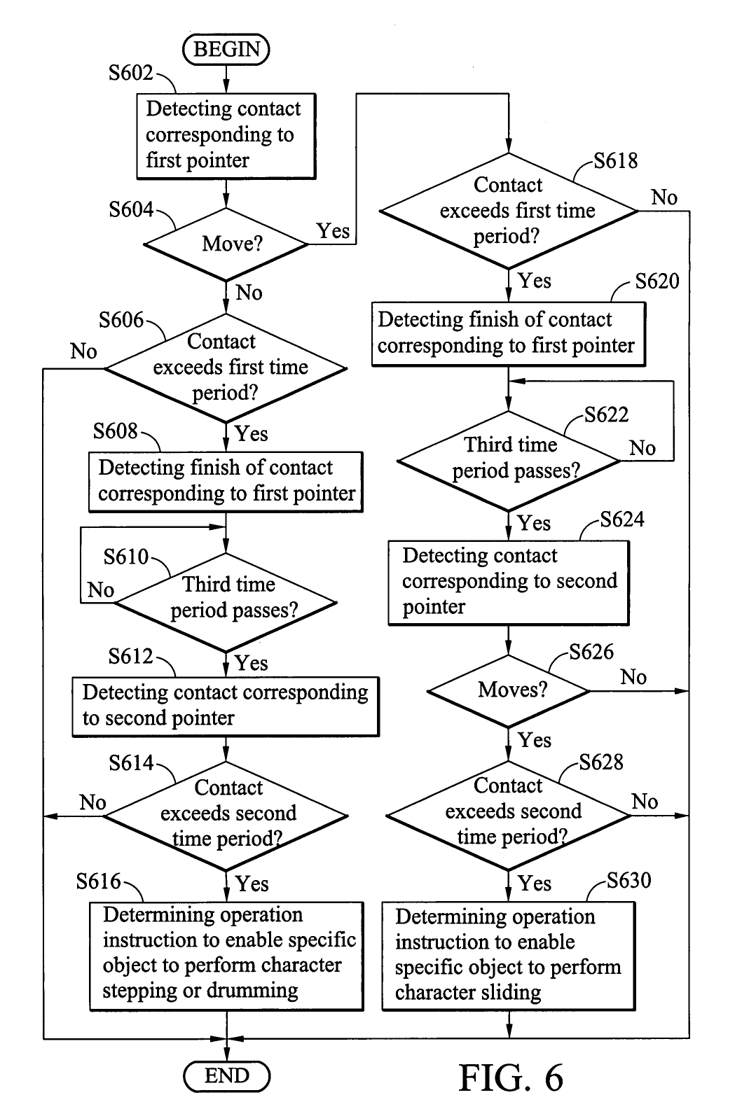

FIG. 6 is a flowchart of an embodiment of a method determining whether a specific operation is character stepping/drumming or character sliding.

In step S602, a contact corresponding to a first pointer is detected. In step S604, it is determined whether the contact corresponding to the first pointer moves. If not (No in step S604), in step S606, it is determined whether the contact corresponding to the first pointer exceeds a first time period. If not, the procedure is complete. If so, in step S608, the finish of the contact corresponding to the first pointer (the first pointer leaves the surface of the touch-sensitive mechanism) is detected. In step S610, it is determined whether a third time period passes. If so, in step S612, a contact corresponding to a second pointer is detected. In step S614, it is determined whether the contact corresponding to the second pointer exceeds a second time period. If not, the procedure is complete. If so, in step S616, the specific operation is determined as character stepping or drumming. If the contact corresponding to the first pointer moves (Yes in step S604), in step S618, it is determined whether the contact corresponding to the first pointer exceeds the first time period. If not, the procedure is complete. If so, in step S620, the finish of the contact corresponding to the first pointer is detected. In step S622, it is determined whether the third time period passes. If so, in step S624, a contact corresponding to the second pointer is detected. In step S626, it is determined whether the contact corresponding to the second pointer moves. If not, the procedure is complete. If so, in step S628, it is determined whether the contact corresponding to the second pointer exceeds the second time period. If not, the procedure is complete. If so, in step S630, the specific operation is determined as character sliding.

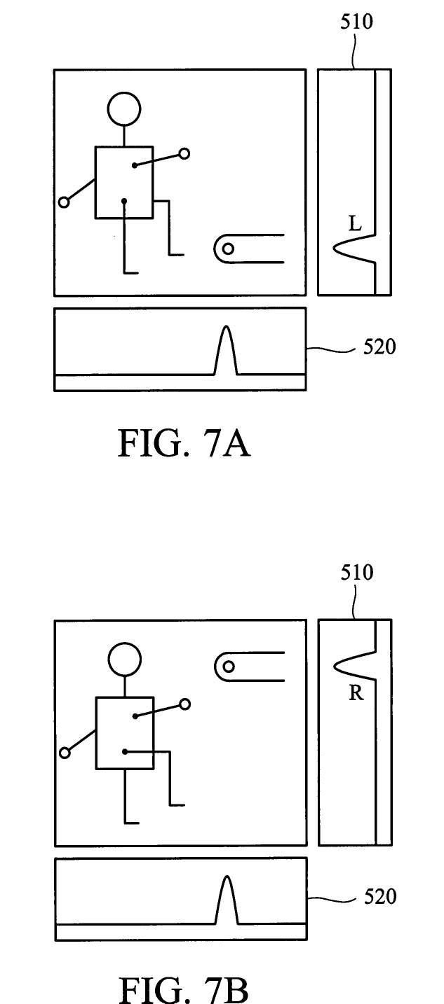

FIGS. 7A and 7B are schematic diagrams illustrating an example of an operation of character stepping.

As shown in FIG. 7A, the first pointer contacts the touch-sensitive mechanism, obtaining a corresponding sensing quantity (L). The first pointer leaves the touch-sensitive mechanism after a time period T1. After a time period T2, the second pointer contacts the touch-sensitive mechanism, obtaining a corresponding sensing quantity (R), as shown in FIG. 7B. The second pointer leaves the touch-sensitive mechanism after a time period T3. It is noted that T1 must exceed the predefined first time period, T2 must exceed the predefined third time period, and T3 must exceed the predefined second time period. After above actions are complete, a character performs a stepping behavior.

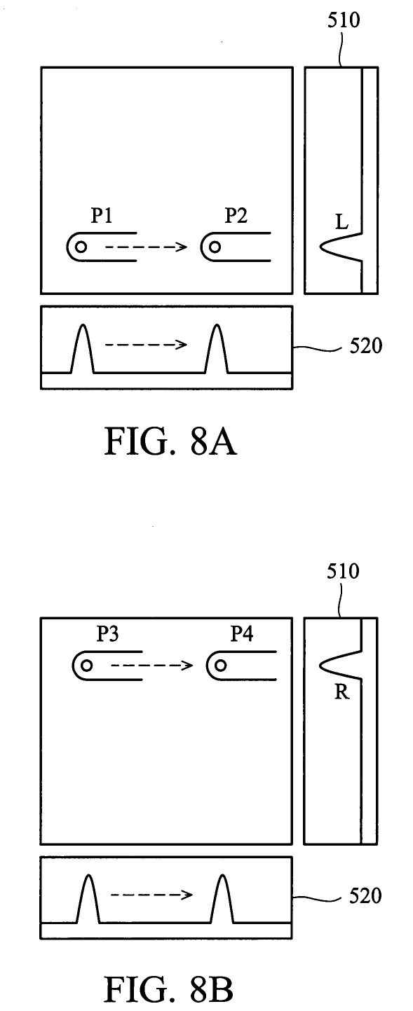

FIGS. 8A and 8B are schematic diagrams illustrating an example of an operation of character sliding.

As shown in FIG. 8A, the first pointer contacts the touch-sensitive mechanism, obtaining a corresponding sensing quantity (L). The first pointer remains on the touch-sensitive mechanism and moves from P1 to P2. The movement of the first pointer can be detected from the curve of sensing quantity in Y axis 520. The first pointer leaves the touch-sensitive mechanism after a time period T1. After a time period T2, the second pointer contacts the touch-sensitive mechanism, obtaining a corresponding sensing quantity (R), as shown in FIG. 8B. The second pointer remains on the touch-sensitive mechanism and moves from P3 to P4. The movement of the second pointer can be detected from the curve of sensing quantity in Y axis 520. The second pointer leaves the touch-sensitive mechanism after a time period T3. Similarly, T1 must exceed the predefined first time period, T2 must exceed the predefined third time period, and T3 must exceed the predefined second time period. After above actions are complete, a character performs a sliding behavior.

Operation control methods and systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An operation control method, comprising:
detecting contacts respectively corresponding to at least two pointers on a touch-sensitive mechanism;
detecting movements of the contacts on the touch-sensitive mechanism; and
determining an operation instruction according to the movements.

2. The method of claim 1 further comprising:
determining whether a sensing quantity corresponding to each pointer exceeds a threshold value; and
if not, ignoring the contact corresponding to the pointer on the touch-sensitive mechanism.

3. The method of claim 1 further comprising:
calculating a first distance between positions of the contacts;
if the contacts remain and move, re-calculating a second distance between positions of the contacts; and
determining whether the second distance exceeds the first distance.

4. The method of claim 3 further comprising:
if the second distance exceeds the first distance, determining the operation instruction to open a specific object according to the contact positions or distance therebetween, wherein the operation instruction comprises an operation of opening a door or hands; and
if the second distance does not exceed the first distance, determining the operation instruction to close the specific object according to the contact positions or distance therebetween, wherein the operation instruction comprises an operation of closing the door or hands.

5. The method of claim 1 further comprising:
determining whether the contacts corresponding to the pointers present alternatively, and if so, determining the operation instruction to enable a specific object to perform a specific operation; and
determining whether the contacts move, if not, determining the specific operation comprises an operation of character stepping or drumming, and if so, determining the specific operation comprises an operation of character sliding.

6. The method of claim 5 wherein the detection of the movements of the contacts on the touch-sensitive mechanism comprises:
detecting a contact corresponding to a first pointer;
detecting a finish of the contact corresponding to the first pointer;
detecting a contact corresponding to a second pointer;
detecting a finish of the contact corresponding to the second pointer, wherein one of the contacts presents on the touch-sensitive mechanism at a time;
determining whether the contact corresponding to the first pointer exceeds a first time period;
determining whether the contact corresponding to the second pointer exceeds a second time period; and
if the contact corresponding to the first pointer exceeds the first time period and the contact corresponding to the second pointer exceeds the second time period, determining the operation instruction.

7. The method of claim 6 further comprising:
determining whether an interval from the finish of the contact corresponding to the first pointer to the presence of the contact corresponding to the second pointer exceeds a third time period; and
if so, determining the operation instruction.

8. The method of claim 1 wherein the at least two pointers comprise a first pointer, a second pointer, and a third pointer, and the method further comprises:
calculating original distances between positions of the contacts corresponding to the first pointer and the second pointer, positions of the contacts corresponding to the second pointer and the third pointer, and positions of the contacts corresponding to the first pointer and the third pointer;
if the contacts remain and move, re-calculating new distances between positions of the contacts corresponding to the first pointer and the second pointer, positions of the contacts corresponding to the second pointer and the third pointer, and positions of the contacts corresponding to the first pointer and the third pointer;
determining whether the new distances between positions of the contacts corresponding to the first pointer and the second pointer, positions of the contacts corresponding to the second pointer and the third pointer, or positions of the contacts corresponding to the first pointer and the third pointer is less then the original distances therebetween; and
if so, determining the operation instruction to catch a specific object.

9. The method of claim 1 further comprising:
outputting the operation instruction to a host; and
displaying a specific object on a display unit, and the host executing the operation instruction by enabling the specific object to perform an operation,
wherein the touch-sensitive mechanism is attached with the display unit, and the contacts respectively correspond to two portions of the specific object.

10. An operation control system, comprising:
a touch-sensitive mechanism; and
a processing module detecting contacts respectively corresponding to at least two pointers on a touch-sensitive mechanism, detecting movements of the contacts on the touch-sensitive mechanism, and determining an operation instruction according to the movements.

11. The system of claim 10 wherein the processing module further determines whether a sensing quantity corresponding to each pointer exceeds a threshold value, and if not, ignores the contact corresponding to the pointer on the touch-sensitive mechanism.

12. The system of claim 10 wherein the processing module further calculates a first distance between positions of the contacts, if the contacts remain and move, re-calculates a second distance between positions of the contacts, and determines whether the second distance exceeds the first distance.

13. The system of claim 12 wherein the processing module further determines the operation instruction to open a specific object according to the contact positions or distance therebetween if the second distance exceeds the first distance, wherein the operation instruction comprises an operation of opening a door or hands, and determines the operation instruction to close the specific object according to the contact positions or distance therebetween if the second distance does not exceed the first distance, wherein the operation instruction comprises an operation of closing the door or hands.

14. The system of claim 10 wherein the processing module further determines whether the contacts corresponding to the pointers present alternatively, if so, determines the operation instruction to enable a specific object to perform a specific operation, determines whether the contacts move, if not, determines the specific operation comprising an operation of character stepping or drumming, and if so, determines the specific operation comprising an operation of character sliding.

15. The system of claim 14 wherein the processing module detects the movements of the contacts on the touch-sensitive mechanism by detecting a contact corresponding to a first pointer, detecting a finish of the contact corresponding to the first pointer, detecting a contact corresponding to a second pointer, detecting a finish of the contact corresponding to the second pointer, wherein one of the contacts presents on the touch-sensitive mechanism at a time, determining whether the contact corresponding to the first pointer exceeds a first time period, determining whether the contact corresponding to the second pointer exceeds a second time period, and determining the operation instruction if the contact corresponding to the first pointer exceeds the first time period and the contact corresponding to the second pointer exceeds the second time period.

16. The system of claim 15 wherein the processing module further determines whether an interval from the finish of the contact corresponding to the first pointer to the presence of the contact corresponding to the second pointer exceeds a third time period, and if so, determines the operation instruction.

17. The system of claim 10 wherein at least two pointers comprise a first pointer, a second pointer, and a third pointer, and the processing module further calculates original distances between positions of the contacts corresponding to the first pointer and the second pointer, positions of the contacts corresponding to the second pointer and the third pointer, and positions of the contacts corresponding to the first pointer and the third pointer, re-calculates new distances between positions of the contacts corresponding to the first pointer and the second pointer, positions of the contacts corresponding to the second pointer and the third pointer, and positions of the contacts corresponding to the first pointer and the third pointer, if the contacts remain and move, determines whether the new distances between positions of the contacts corresponding to the first pointer and the second pointer, positions of the contacts corresponding to the second pointer and the third pointer, or positions of the contacts corresponding to the first pointer and the third pointer is less then the original distances therebetween, and if so, determines the operation instruction to catch a specific object.

18. The system of claim 10 further comprising a host and a display unit, wherein the processing unit further outputs the operation instruction to the host, the host displays a specific object on the display unit, and executes the operation instruction by enabling the specific object to perform an operation, wherein the touch-sensitive mechanism is attached with the display unit, and the contacts respectively correspond to two portions of the specific object.

19. A machine-readable storage medium comprising a computer program, which, when executed, causes a device to perform an operation control method, the method comprising:
detecting contacts respectively corresponding to at least two pointers on a touch-sensitive mechanism;
detecting movements of the contacts on the touch-sensitive mechanism; and
determining an operation instruction according to the movements.
